(19) United States
(12) Patent Application Publication
(10) Pub. No.: US 2010/0000144 A1
(43) Pub. Date: Jan. 7, 2010

(54) Adjustable fishing rod holder

(76) Inventor: A Mei Yang, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/217,017

(22) Filed: Jul. 1, 2008

(51) Int. Cl. A01K 97/10

(52) U.S. Cl. 43/21.2

(57) ABSTRACT

A fishing rod holder includes an arm attached to a bracket, a U-shaped holding member attached to one end of the arm and a C-shaped holding member attached to the other end of the arm for supporting a fishing rod and for allowing the arm to be easily and quickly moved or adjusted relative to the bracket to any suitable or selected angular position. The arm includes a curved middle portion slidably and adjustably attached to the bracket with a seat and a fastener. The C-shaped holding member includes a lower end changeably secured to the arm and selectively faced either leftward for being used with a left-handed person or rightward for being used with a right-handed person.

### BACKGROUND OF THE INVENTION

1. Field of the Invention

The present invention relates to a fishing rod holder, and more particularly to a fishing rod holder including an adjustable structure for allowing the fishing rod holder to be tilted or adjusted to any suitable or selected posture and for allowing the user to easily operate the fishing rod holder.

2. Description of the Prior Art

Typical fishing rod holders comprise a swivel device for supporting a fishing rod in which the rod is pivotally supported at its center or near center of gravity, and the fishing rod is free to swing about horizontal and vertical axes.

For example, U.S. Pat. No. 4,161,839 to Ward discloses one of the typical swivel devices for supporting a balanced or semi-balanced fishing rod and indicating when a fish strikes, and comprising a cylindrical clamp pivotally supported in a clevis with trunnion bearings for engaging with a fishing rod, and a wing-shaped head threaded to the cylindrical clamp for clamping the fishing rod to the cylindrical clamp.

However, it takes time to thread or rotate the wing-shaped head relative to the cylindrical clamp, such that the user will be busy particularly when a fish strikes. In addition, the fishing rod may only be supported by the cylindrical clamp that is pivotally supported in the clevis such that the fishing rod may not be stably supported in place.

U.S. Pat. No. 5,355,610 to Sizemore et al. discloses another typical fishing rod supporting device comprising a C-shaped support located rearwardly of a rectangular support box to receive the rear of a handle of a fishing rod, and a second support component positioned forwardly of the rectangular support box to receive the front of the handle of the fishing rod, and the second support component is resiliently supported on the rectangular support box with two springs for allowing the second support component to be forced or depressed or moved downwardly by the fishing rod when a fish strikes.

However, the C-shaped support is solidly secured to the rectangular support box and may not be adjusted relative to the rectangular support box, and thus may not be used by either the right-handed person or the left-handed person. In addition, the C-shaped support may not be adjusted up and down relative to the rectangular support box.

U.S. Pat. No. 7,017,296 to Templeman et al. discloses a further typical fishing rod supporting device comprising a tubular portion supported on the base with a pivot hinge, a trigger arm support and a tensioning spring.

However, the tubular portion may only be used to support the rear portion of the handle of the fishing rod, and the handle of the fishing rod may not be moved or adjusted forwardly and rearwardly relative to the tubular portion. In addition, the base and the tubular portion include a predetermined structure that may not be easily attached or secured onto various supporting objects.

The present invention has arisen to mitigate and/or obviate the afore-described disadvantages of the conventional fishing rod holders.

### SUMMARY OF THE INVENTION

The primary objective of the present invention is to provide a fishing rod holder including an adjustable structure for allowing the fishing rod holder to be tilted or adjusted to any suitable or selected posture and for allowing the user to easily operate the fishing rod holder.

In accordance with one aspect of the invention, there is provided a fishing rod holder comprising a bracket, an arm attached to the bracket and including a first end and a second end, a U-shaped holding member attached to the first end of the arm for supporting a fishing rod, and a C-shaped holding member attached to the second end of the arm for supporting the fishing rod and for allowing the arm to be easily and quickly moved or adjusted relative to the bracket to any suitable or selected position.

The arm includes a middle portion slidably and adjustably attached to the bracket for adjusting to any suitable or selected position relative to the bracket. The middle portion of the arm preferably includes a curved structure for allowing the arm to be curved or adjusted relative to the bracket to any suitable or selected angular position.

The bracket includes a seat attached thereto, the middle portion of the arm is engaged with the seat and secured to the bracket with a fastener. The seat includes a channel formed therein for slidably receiving the middle portion of the arm and for allowing the arm to be moved or adjusted relative to the bracket.

The seat includes two side fences for forming the channel between the two side fences of the seat. The arm includes a groove formed in the middle portion thereof for slidably and adjustably receiving the fastener and for easily and quickly adjusting the arm relative to the bracket. The bracket includes a serrated anvil formed thereon for frictionally engaging with the seat.

The C-shaped holding member includes a lower end changeably secured to the second end of the arm and selectively faced either leftward for being used with a left-handed person or rightward for being used with a right-handed person.

The lower end of the C-shaped holding member may be adjustably secured to the second end of the arm with a fastener, or may be solidly secured to the second end of the arm, and the C-shaped holding member may be faced either leftward or rightward.

The bracket includes a base plate, and two flaps extended from the base plate for forming an opened space between the flaps and the base plate, the bracket is attached to either the base plate or one of the flaps. The bracket includes a bolt engaged with one of the flaps for detachably securing the bracket to various supporting objects, such as the side portions of the fishing boats, or other supporting wall members.

The base plate and the bolt may be arranged either horizontally or vertically for conveniently attaching or securing to various supporting objects. The bolt may include a contact head provided on one end for engaging with the supporting objects, and a knob formed or provided on the other end for being rotated or operated by the user.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a fishing rod holder in accordance with the present invention;

FIG. 2 is a perspective view similar to FIG. 1 illustrating the operation of the fishing rod holder;

FIG. 3 is another perspective view similar to FIGS. 1 and 2 illustrating another fishing rod holder for being used with a left-handed person; and

FIG. 4 is a further perspective view similar to FIGS. 1-3 illustrating a further fishing rod holder for being used with a right-handed person.

### DETAILED DESCRIPTION OF THE PREFERRED EMBODIMENT

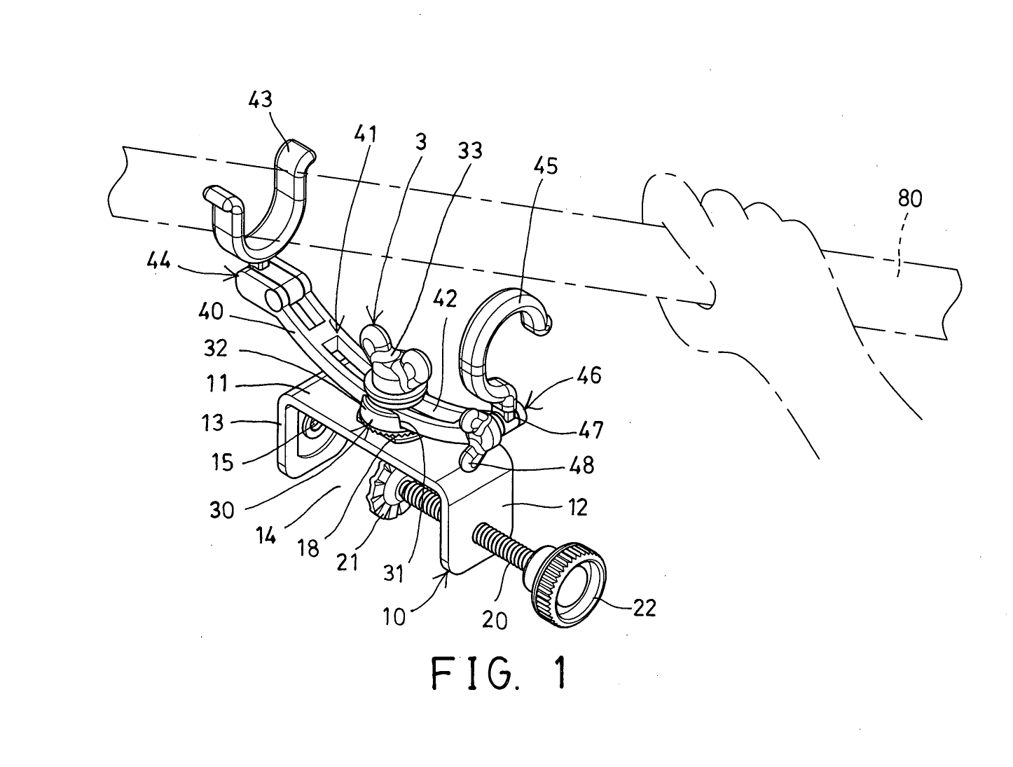

Referring to the drawings, and initially to FIG. 1, a fishing rod holder in accordance with the present invention comprises a clevis or bracket 10 including a U or C-shaped structure having a base plate 11, and two flaps 12, 13 bent or extended from the base plate 11 and preferably perpendicular to the base plate 11 for forming or defining an opened space 14 between the flaps 12, 13 and the base plate 1 1 and for allowing the space 14 of the bracket 10 to receive various supporting objects, such as the side portions of the fishing boats, or other supporting wall members (not shown).

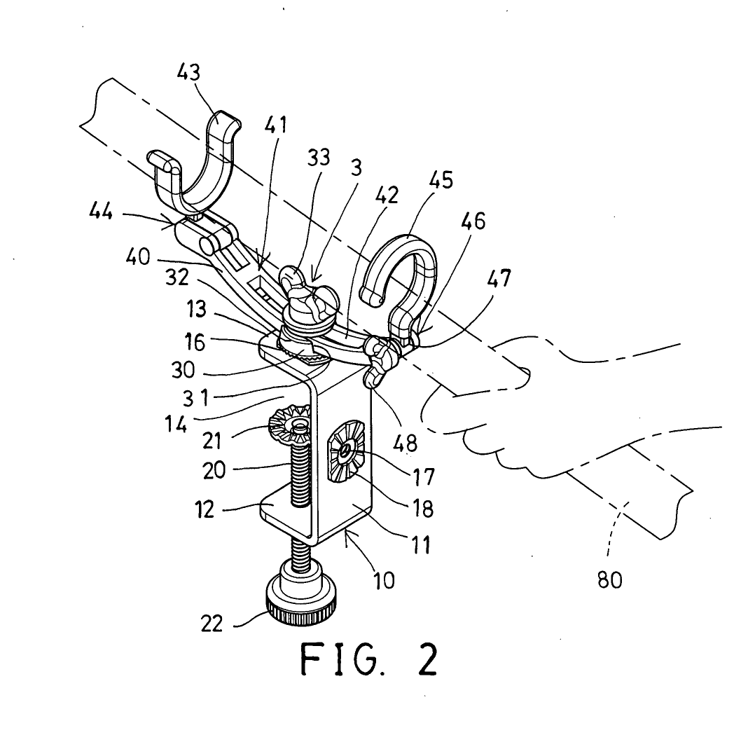

The bracket 10 may further include a screw hole 15 (FIG. 1, 3, 4) formed in the other flap 13, and another screw hole 17 (FIG. 2) formed in the base plate 11 for selectively attaching or engaging with a fastening means or device 3, and may further include an anvil 16, such as a serrated anvil 16 formed or provided on the outer portion of the other flap 13 and formed or located around the screw hole 15, and another anvil 18, such as a serrated anvil 18 formed or provided on the outer portion of the base plate 11 and formed or located around the screw hole 17.

A fastener or screw or bolt 20 is threaded or engaged with one of the flaps 12 and preferably arranged parallel to the base plate 11, and includes a contact head 21 provided on one end or inner end thereof for engaging with the supporting objects and for detachably securing the bracket 10 to the supporting objects, and includes a knob 22 formed or provided on the other end or outer end thereof for being rotated or operated by the user. It is to be noted that the base plate 11 and the bolt 20 may be arranged either horizontally (FIG. 1, 3, 4) or vertically (FIG. 2) for conveniently attaching or securing to various supporting objects.

The fastening means or device 3 includes a seat 30 for selectively attaching or engaging with either of the anvils 16, 18 of the bracket 10, and the seat 30 includes a channel 31 formed therein and formed or defined by two end or side fences 32, and a fastener 33, such as a wing-shaped fastener 33 is engaged through the seat 30 and threaded or engaged with either of the screw holes 15, 17 of the bracket 10 for detachably securing the seat 30 of the fastening device 3 to either the other flap 13 (FIG. 2) or the base plate 11 (FIG. 1, 3, 4) of the bracket 10.

A C-shaped or curved arm 40 is preferably arranged or curved upwardly and includes a middle portion 41 slidably engaged with or in the channel 31 of the seat 30, and includes a groove 42 formed in the middle portion 41 thereof for slidably receiving or engaging with the fastener 33, and for allowing the curved arm 40 to be easily and quickly moved or adjusted relative to the seat 30 and the bracket 10 to any suitable or selected angular position. The curved arm 40 further includes a U-shaped holding member 43 disposed or attached to one end 44 thereof for supporting the middle portion of a fishing rod 80.

The curved arm 40 further includes a C-shaped holding member 45 disposed or attached to the other end 46 thereof also for supporting the fishing rod 80, and the lower end 47 of the C-shaped holding member 45 is adjustably or changeably secured to the other end 46 of the curved arm 40 with another latch or fastener 48 for allowing the C-shaped holding member 45 to be selectively faced either leftward for being used with a left-handed person (FIG. 2) or rightward for being used with a right-handed person (FIG. 1, 3, 4) and for allowing the fishing rod holder to be easily operated by the user.

It is to be noted that the U-shaped holding member 43 is disposed or attached to one end 44 of the arm 40, and the C-shaped holding member 45 is disposed or attached to the other end 46 of the arm 40, and the fishing rod 80 may be stably supported by the holding members 43, 45 and may be easily and quickly adjusted relative to the seat 30 and the bracket 10 to any suitable or selected angular position, and may be easily and quickly and solidly secured to the bracket 10 with the seat 30 and the fastener 33 of the fastening device 3. The typical fishing rod holders failed to provide a U-shaped holding member 43 at one end 44 of an arm 40 and a C-shaped holding member 45 at the other end 46 of the arm 40 for stably supporting the fishing rod 80, and the typical fishing rod holders also failed to provide a bracket 10 for conveniently attaching or securing to various supporting objects either horizontally or vertically.

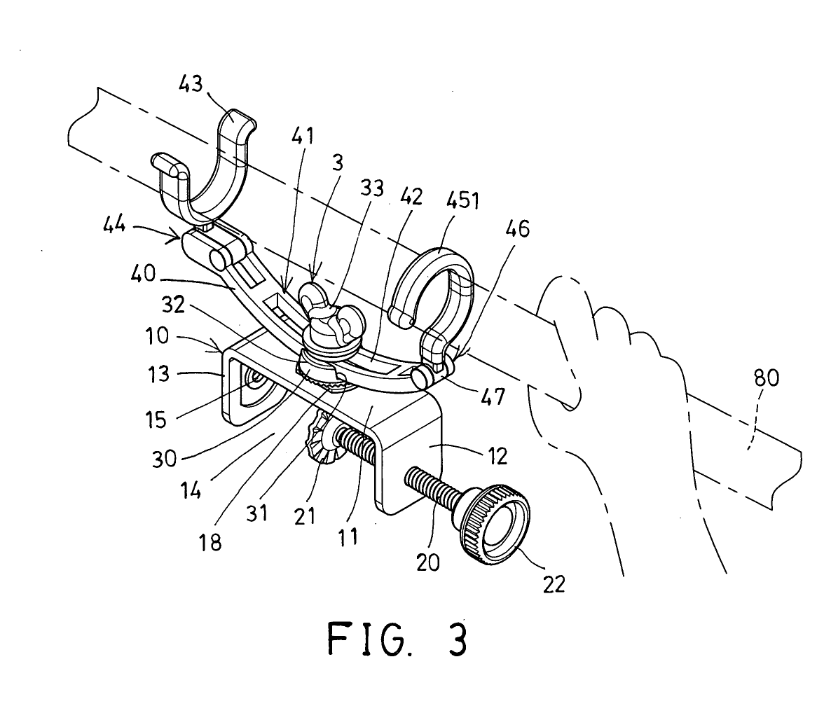

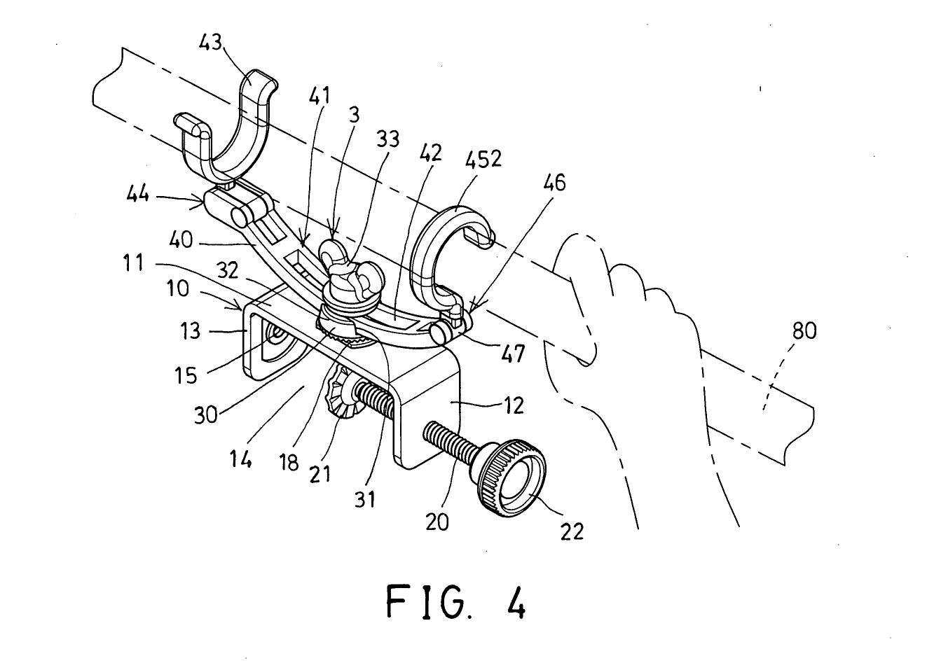

Alternatively, as shown in FIG. 3, the C-shaped holding member 451 may be solidly disposed or attached to the other end 46 of the arm 40 and faced leftward for being used with a left-handed person; and as shown in FIG. 4, the C-shaped holding member 452 may be solidly disposed or attached to the other end 46 of the arm 40 and faced rightward for being used with a right-handed person and for allowing the fishing rod holder to be easily operated by the user.

Accordingly, the fishing rod holder in accordance with the present invention includes an adjustable structure for allowing the fishing rod holder to be tilted or adjusted to any suitable or selected posture and for allowing the user to easily operate the fishing rod holder.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fishing rod holder comprising:
a bracket,
an arm attached to said bracket and including a first end and a second end,
a U-shaped holding member attached to said first end of said arm for supporting a fishing rod, and
a C-shaped holding member attached to said second end of said arm for supporting the fishing rod.

2. The fishing rod holder as claimed in claim 1, wherein said arm includes a middle portion slidably and adjustably attached to said bracket.

3. The fishing rod holder as claimed in claim 2, wherein said middle portion of said arm includes a curved structure.

4. The fishing rod holder as claimed in claim 2, wherein said bracket includes a seat attached thereto, said middle portion of said arm is engaged with said seat and secured to said bracket with a fastener.

5. The fishing rod holder as claimed in claim 4, wherein said seat includes a channel formed therein for slidably receiving said middle portion of said arm.

6. The fishing rod holder as claimed in claim 5, wherein said seat includes two side fences for forming said channel of said seat.

7. The fishing rod holder as claimed in claim 4, wherein said arm includes a groove formed in said middle portion thereof for slidably and adjustably receiving said fastener.

8. The fishing rod holder as claimed in claim 4, wherein said bracket includes a serrated anvil formed thereon for engaging with said seat.

9. The fishing rod holder as claimed in claim 1, wherein said C-shaped holding member includes a lower end changeably secured to said second end of said arm and selectively faced either leftward for being used with a left-handed person or rightward for being used with a right-handed person.

10. The fishing rod holder as claimed in claim 9, wherein said lower end of said C-shaped holding member is secured to said second end of said arm with a fastener.

11. The fishing rod holder as claimed in claim 1, wherein said bracket includes a base plate, and two flaps extended from said base plate for forming an opened space between said flaps and said base plate, said bracket is attached to either said base plate or said flap.

12. The fishing rod holder as claimed in claim 11, wherein said bracket includes a bolt engaged with one of said flaps.
